(19) United States
(12) Patent Application Publication
(10) Pub. No.: US 2008/0232016 A1
(43) Pub. Date: Sep. 25, 2008

(54) Power control circuit with alarm

(76) Inventors: Chao Chen, Guangdong (CN); Shan Wang, Hunan (CN)

Correspondence Address: ERIC CHAN, 42 PIN OAKS DRIVE, PHOENIXVILLE, PA, 19460, US

(21) Appl. No.: 11/688,887

(22) Filed: Mar. 21, 2007

(51) Int. Cl. H02H 3/08

(52) U.S. Cl. 361/93.1

(57) ABSTRACT

A power control circuit with alarm, comprising a MCU control circuit, wherein further comprising a step down commute circuit, a power detecting circuit, a voltage regulate circuit, a complementary comparison circuit and a feedback compensating circuit, a cut-off control circuit. Said power detecting circuit and said step down commute circuit are connected in parallel. The input ends of power complementary comparing circuit and temperature negative feedback compensating circuit are connected to the output end of the power detecting circuit. The output ends of power complementary comparison circuit and temperature negative feed back compensating circuit are connected to the input end of MCU control circuit. Said step down commute circuit, voltage regulate circuit, MCU control circuit are connected in turn and in cascade. The output end of MCU control circuit is connected to the input end of power cut-off control circuit. The power cut-off control circuit are connected to the control switch on the power supply loop of the electrical equipment. It is a small power control circuit with alarm, which is easy to install, able to control the rated power below 190W.

### BACKGROUND OF THE INVENTION

The present invention relates to a power control circuit with alarm, more particularly, relates to a power control circuit with alarm, which may control the rated power below 190 W.

The power control mode of the general 120V/60 Hz AC equipments in the market nowadays, usually is by voltage and power sensor to detect and control. Thus the configuration of the circuit is large and complex. It is inconvenient and cost ineffective for mass production, thus to affect the stability of the circuit. The disadvantages of the traditional power control circuit are: first, when control circuit detects power overload, power supply is cut off immediately, there is no other alarm provided, the user would think the power supply is cut off because of trouble occurred in other components of the equipment; second, if power supply is cut off by the control circuit, the switch must be enabled manually, and cannot be enabled automatically; third, the control circuit cannot be applied in various types of control switch and manual or remote controller; at last, since the control circuit is large, it is difficult for installation, therefore, it can only be applied selectively, or the outlook of the equipment must be redesigned.

### BRIEF SUMMARY OF THE INVENTION

The object of the present invention is to solve the defects in the prior art, and to provide a small power control circuit with alarm, which is easy to install, able to control the rated power below 190 W.

The technical solution of the present invention is: construct a power control circuit with alarm, which comprising a MCU control circuit, wherein further comprising a step down commute circuit, a power detecting circuit, a voltage regulate circuit, a complementary comparison circuit and a feedback compensating circuit, a cut-off control circuit. Said power detecting circuit and said step down commute circuit are connected in parallel. The input ends of the power complementary comparing circuit and temperature negative feedback compensating circuit are connected to the output end of the power detecting circuit. The output ends of the power complementary comparison circuit and temperature negative feed back compensating circuit are connected to the input end of MCU control circuit. Said step down commute circuit, voltage regulate circuit and MCU control circuit are connected in turn and in cascade. The output end of the MCU control circuit is connected to the input end of the power cut-off control circuit. The power cut-off control circuit are connected to the control switch on the power supply loop of the electrical equipment.

Advantageously, said MCU control circuit is further connected with an alarm.

The benefits of implementing the present invention are: constructing a control circuit formed by MCU control circuit, step down commute circuit, power detection circuit, voltage regulate circuit, power complementary comparison circuit and temperature negative feedback compensating circuit, power supply cut-off control circuit. Said power detecting circuit and step down commuting circuit are connected in parallel. The input end of the power complementary comparison circuit and power negative feedback compensating circuit are connected to the output end of power detecting circuit. The output ends of power complementary comparison circuit and temperature negative feed back compensating circuit are connected to the input end of MCU control circuit. Said step down commute circuit, voltage regulate circuit and MCU control circuit are connected in turn and in cascade. The output end of MCU control circuit are connected to the input end of power cut-off control circuit. The power cut-off control circuit are connected to the control switch on the power supply loop of the electrical equipment. It is a small power control circuit with alarm, which is easy to install, able to control the rated power below 190 W.

Various aspects of the present invention will be described in accordance with the drawings and embodiments.

### BRIEF DESCRIPTION OF THE DRAWINGS

FIG. 1 is the structure diagram of the power control circuit with alarm, in accordance with the present invention;

FIG. 2 is the circuit principle of the power control circuit with alarm, in accordance with the present invention.

### DETAILED DESCRIPTION OF THE INVENTION

Preferred embodiment of the present invention is described below; however, the scope of the present invention is not limited to particular embodiments.

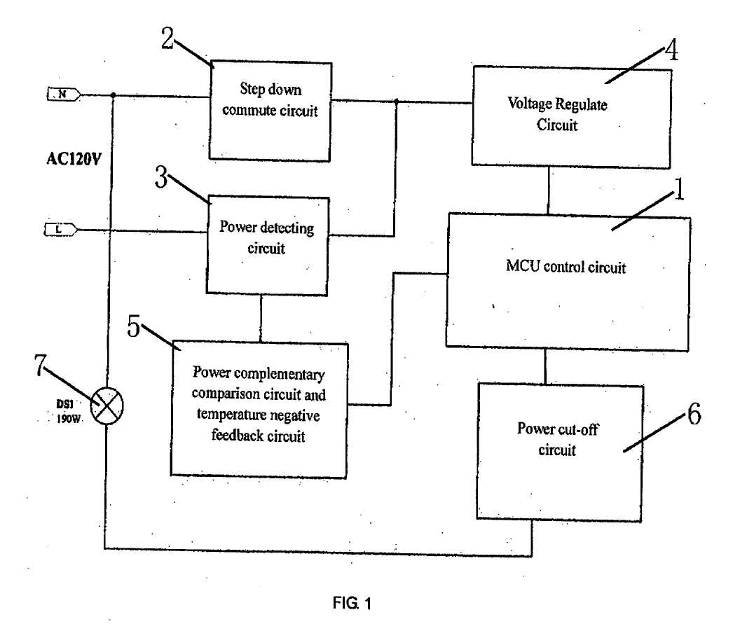

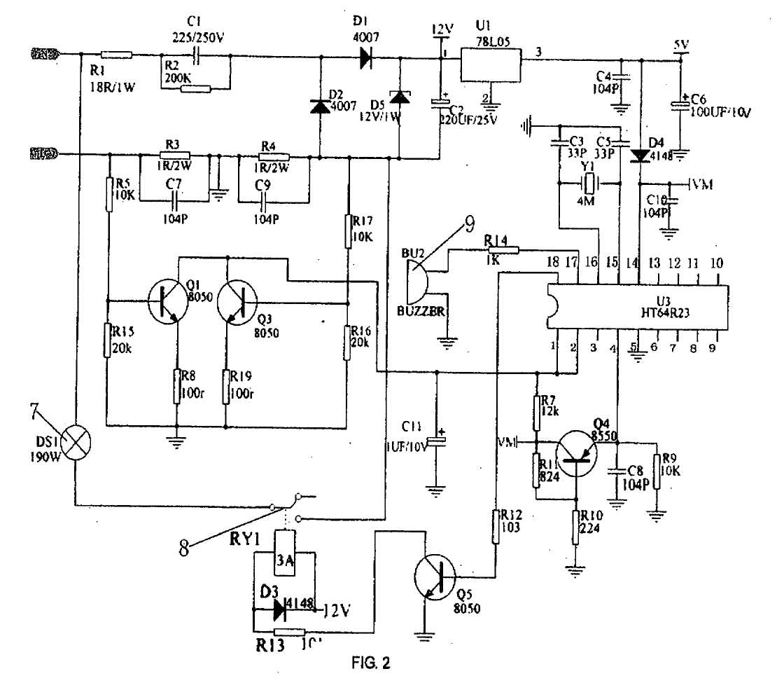

Referring to FIGS. 1 and 2, a power control circuit with alarm is provided, which comprising a MCU control circuit 1, wherein further comprising a step down commute circuit 2, a power detecting circuit 3, a voltage regulate circuit 4, a complementary comparison circuit and a feedback compensating circuit 5, a cut-off control circuit 7. Said power detecting circuit 3 and said step down commute circuit 2 are connected in parallel. The input ends of power complementary comparing circuit and temperature negative feedback compensating circuit 5 are connected to the output end of the power detecting circuit 3. The output ends of power complementary comparison circuit and temperature negative feed back compensating circuit 5 are connected to the input end of MCU control circuit 1. Said step down commute circuit 2, voltage regulate circuit 4 and MCU control circuit 1 are connected in turn and in cascade. The output end of MCU control circuit 1 are connected to the input end of power cut-off control circuit 6. The power cut-off control circuit 6 is connected to the control switch 8 on the power supply loop of the electrical equipment 7. Said MCU control circuit 1 is further connected with an alarm 9. When the power of the electrical equipment exceeds 190 W, the MCU control circuit 1 will transmits a control signal to the power cut-off circuit 6 to disconnect with the control switch 8 on the power supply loop of electrical equipment 7, thus to cut off the power supply, meanwhile, the MCU control circuit 1 transmits an alarm signal to alarm 9. The alarm will flash every 5 seconds to indicate the user the power of electrical equipment 7 has exceeded the rated power of 190 W. When the power of the electrical equipment 7 falls below the rated power of 190 W, the electrical equipment 7 will automatically return to work.

Said power control circuit of the present invention may control the power of the electrical equipment 7 under 190 W, it is also provided with an alarm. The power control circuit in the present invention is small and easy to install, it may be utilized in different electrical equipments 7, for example, a fan light, lamp, reading lamp, droplight, wall light and dome light, etc.

What is claimed is:

1. A power control circuit with alarm, comprising a MCU control circuit (1), wherein further comprising a step down commute circuit (2), a power detecting circuit (3), a voltage regulate circuit (4), a complementary comparison circuit and a feedback compensating circuit (5), a power cut-off control circuit (6). Said power detecting circuit (3) and said step down commute circuit (2) are connected in parallel; the input ends of the power complementary comparing circuit and temperature negative feedback compensating circuit (5) are connected to the output end of the power detecting circuit (3); the output ends of the power complementary comparison circuit and temperature negative feed back compensating circuit (5) are connected to the input end of MCU control circuit (1); said step down commute circuit (2), voltage regulate circuit (4) and MCU control circuit (1) are connected in turn and in cascade; the output end of MCU control circuit (1) is connected to the input end of power cut-off control circuit (6); the power cut-off control circuit (6) is connected to the control switch (8) on the power supply loop of the electrical equipment (7).

2. The power control circuit with alarm as in claim 1, wherein said MCU control circuit (1) is further connected with an alarm (9).
